(19) United States
(12) Patent Application Publication
(10) Pub. No.: US 2009/0223360 A1
(43) Pub. Date: Sep. 10, 2009

(54) Actuator

(75) Inventors: Masashi Aoki, Aichi-ken (JP); Hajime Kitte, Aichi-ken (JP); Hirokazu Matsuura, Aichi-ken (JP); Takeki Hayashi, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/379,883

(22) Filed: Mar. 3, 2009

(30) Foreign Application Priority Data
Mar. 5, 2008 (JP) P2008-055551

(51) Int. Cl. F15B 15/26

(52) U.S. Cl. 92/15

(57) ABSTRACT

An actuator includes a cylinder, a piston rod which moves forwards within the cylinder and a lock mechanism for restricting a backward movement of the piston rod that has moved forwards. The piston rod includes a piston portion and a support rod portion which is made to extend from the piston portion. The lock mechanism includes an annular elastic element which is disposed with an inner circumferential edge made to project further radially inwards than an inner circumferential surface of the cylinder and a groove which is disposed so as to extend along an outer circumferential surface of the piston portion for the annular elastic element to be fitted therein. The support rod portion includes a rod main body portion whose diameter is made smaller than an inside diameter of the annular elastic element and a tapered portion which is disposed on a piston portion side end portion of the support rod portion and which has a taper surface which is gradually expanded diametrically towards the piston portion until an outside diametrical dimension of the piston portion is reached.

### BACKGROUND OF THE INVENTION

1. Field of the Invention

The present invention relates to an actuator for use in automotive safety equipment and more particularly to, for example, an actuator for use in an operation such as one for raising a hood panel of an automobile when receiving a pedestrian as an object to be protected by the hood panel.

2. Related Art

Conventionally, as actuators for safety equipment mounted on motor vehicles, there have been actuators for raising a rear end of a hood panel so as to receive a pedestrian by the hood panel itself by making use of energy absorption taking place when the hood panel is plastically deformed (for example, refer to JP-A2004-330913).

As the actuators for raising the hood panel, there have been actuators which were configured as actuators of a piston cylinder type in which gas generated when a gas generator was activated was used as a drive source, so as to be put into operation quickly. In the actuators so configured, gas generated as working fluid when the gas generator was activated was filled within the cylinder so as to raise the piston rod housed in the cylinder, so that the hood panel connected to an upper end of the piston rod could be raised. In addition, the piston rod was constructed into something like one in which the piston was integrated with a support rod which extended from the piston so as to support the hood panel. In addition, in the actuator configured as the piston cylinder type, a lock mechanism was built therein so as to restrict a descending movement of the piston rod that had once been raised relative to the cylinder so as to prevent the descending movement of the hood panel after the hood panel had once been raised by gas from the gas generator being filled within the cylinder.

In addition, as the gas generator, a micro gas generator was used in which gunpowder or gas generating chemicals were ignited by an activation signal being inputted thereinto, and in the gas generator like this, gas generated by burning of gunpowder or chemical reaction of gas generating chemicals (reaction such as oxidation or oxidative combustion) was used to move the piston rod.

However, in the conventional actuators, as the construction of the lock mechanism, the construction was adopted in which the annular elastic element such as a snap ring which is elastically deformed in a diametrically contracting direction was provided on the inner circumferential surface side of the cylinder, the outer circumferential surface side of the piston rod was made to slide relative to the inner circumferential surface of the cylinder over substantially the full length thereof, and the groove into which the annular elastic element was to be fitted was provided in the position on the outer circumferential surface of the piston rod where the piston rod was desired to be locked.

In the conventional actuators that were configured in the way described above, since the outer circumferential surface of the piston rod was constructed in such a manner as to slide, over substantially the full length thereof, on the inner circumferential surface of the cylinder, the annular elastic element provided on the inner circumferential surface side of the cylinder was caused to press against the outer circumferential surface of the piston rod in the diametrically contracting direction at all times while the piston rod was moving upwards. Since this pressure acted as sliding resistance to the ascending piston rod, the smooth forwarding movement (ascending movement) of the piston rod was interrupted.

### SUMMARY OF THE INVENTION

The invention has been made with a view to solving the problem, and an object thereof is to provide an actuator which can allow a piston rod to move forwards as smoothly as possible although a configuration is adopted in which an annular elastic element is used in a lock mechanism.

With a view to achieving the object, according to an aspect of the invention, there is provided an actuator for use in automotive safety equipment, including a cylinder, a piston rod disposed so as to be able to move forwards within the cylinder, and a lock mechanism for restricting a backward movement of the piston rod that has once moved forwards,

the piston rod including:

a piston portion which moves forwards when in operation; and

a support rod portion extended from the piston portion in a forward direction, so as to project from a distal end wall portion of the cylinder to support a receiving member for receiving an object to be protected,

the lock mechanism including:

an annular elastic element provided in a position on an inner circumferential surface side of the cylinder where the piston rod is disposed after the piston rod has moved forwards such that an inner circumferential edge is made to project further than an inner circumferential surface of the cylinder and adapted to expand diametrically in a restorable manner; and

a groove provided along an outer circumferential surface of the piston portion so that the annular elastic element is allowed to be fitted therein so as to restrict a backward movement of the piston rod that has once moved forwards, wherein

the support rod portion includes:

a rod main body portion having a smaller diameter than an inside diametrical dimension of the annular elastic element and adapted to project from the distal end wall portion of the cylinder when the piston rod moves forwards; and

a tapered portion provided at a piston portion side end portion of the support rod portion and having a taper surface which is gradually expanded diametrically towards the piston portion until an outside diametrical dimension of the piston portion is reached.

In the actuator according to the aspect of the invention, since the outside diameter of the rod main body portion which projects from the distal end wall portion of the cylinder when the piston rod moves forwards is made to be smaller than the inside diameter of the annular elastic element, when the actuator is activated so that the piston portion of the piston rod disposed within the cylinder moves forwards, the outer circumferential surface of the rod main body portion of the support rod portion which extends from the piston portion is not brought into press contact with the inner circumferential surface of the annular elastic element. Namely, since there is no situation in which the rod main body portion is pressed against by the elastic force in the diametrically contracting direction that is possessed or applied by the annular elastic element when the piston rod moves forwards, the piston rod can move forwards in a smooth fashion.

Thereafter, since the tapered portion of the support rod portion expands gradually the inside diameter of the annular elastic element to the outside diametrical dimension of the piston portion when the tapered portion passes through the position where the annular elastic element is provided, the annular elastic element comes to have a biasing force in a diametrically contracting direction for it to fit into the groove in the piston portion. Following this, when the piston rod has completed its forward movement, the annular elastic element is restored in the diametrically contracting direction and fits in the groove in the piston portion, thereby making it possible to restrict a backward movement of the piston rod. Then, the expanded portion does not have to be provided along the full length of the support rod portion as long as the tapered portion has the taper surface tapered at such an angle to diametrically expand the annular elastic element smoothly to the outside diameter of the piston portion, and hence, the tapered portion can be configured in a short length dimension. Because of this, in proportion to the reduction in length of the tapered portion, the piston rod can move forwards more quickly until the support rod portion brings the tapered portion into contact with the annular elastic element.

Consequently, in the actuator according to the aspect of the invention, even though the configuration is adopted in which the annular elastic element is used in the lock mechanism, the piston rod can be made to move forwards as smoothly as possible.

In addition, a snap ring made of a spring steel can be raised as an example for use for the annular elastic element of the invention of the subject patent application. Additionally, the object to be protected is not limited to a pedestrian or an occupant of a vehicle but can include, for example, a body component such as a bumper.

In addition, the pressure of an operating fluid such as oil, water and gas like air, the suction force of a solenoid, and the biasing force (restoring force) of a compressed spring can be used as a drive source for moving the piston rod.

### BRIEF DESCRIPTION OF THE DRAWINGS

FIG. 1 is a perspective view of a vehicle which is equipped with a pedestrian protection system to which an actuator of an embodiment of the invention is applied.

FIG. 2 is a plan view of an enlarged portion of the vehicle equipped with the pedestrian protection system to which the actuator of the embodiment is applied.

FIG. 3 is a schematic vertical sectional view of the pedestrian protection system of the embodiment taken along a longitudinal direction of the vehicle, which corresponds to a portion indicated by the line III-III in FIG. 2.

FIG. 4 is a schematic vertical sectional view showing the pedestrian protection system of the embodiment which is being activated.

FIG. 5 is a schematic diagram showing a state in which a support rod portion of the actuator of the embodiment is plastically deformed.

FIGS. 6A and 6B are schematic vertical sectional views of the actuator of the embodiment showing states resulting before the actuator is activated and when the actuation has been completed.

FIGS. 7A to 7C are vertical sectional views of an enlarged portion of the actuator of the embodiment showing a process from diametric expansion of an annular elastic element to fitment thereof in a groove.

FIGS. 8A and 8B are schematic horizontal sectional views of a portion of the actuator of the embodiment where the annular elastic element making up a lock mechanism is disposed showing states resulting before the actuator is activated and when the actuator has been completely activated, the portion corresponding to the portion indicated by the line III-III in FIGS. 6A and 6B.

FIGS. 9A and 9B are diagrams showing a modified example to the embodiment.

### DETAILED DESCRIPTION OF THE PREFERRED EMBODIMENTS

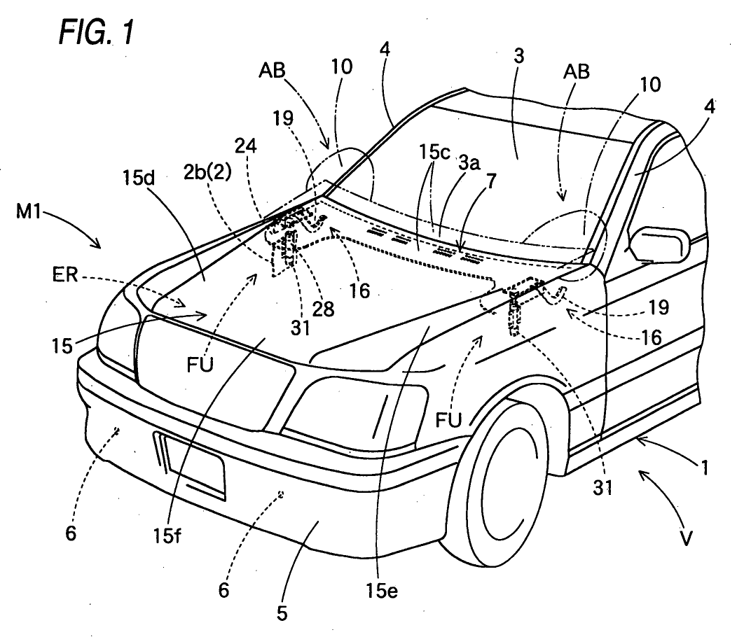

Hereinafter, an embodiment of the invention will be described based on accompanying drawings. As is shown in FIGS. 1 to 4, an actuator 31 of the embodiment is an actuator for use in a hood lift-up apparatus (hereinafter, referred to simply as a lift-up apparatus) FU in a pedestrian protection system M1 as automotive safety equipment mounted on a vehicle V. This lift-up apparatus FU raises a rear end 15c of a hood panel 15 when the actuator 31 is activated to operate. In addition, such actuators 31 of the embodiment are provided underneath the hood panel 15 of the vehicle V in positions which lie in the vicinity of side edges, a left-hand edge 15d and a right-hand edge 15e, and in the vicinity of the rear end 15c of the hood panel 15, respectively. The pedestrian protection system M1 includes the lift-up apparatus FU for raising the rear end 15c of the hood panel 15 functioning as a receiving member for receiving a pedestrian and an air bag apparatus AB having an air bag 10 which protects a pedestrian from a front pillar 4.

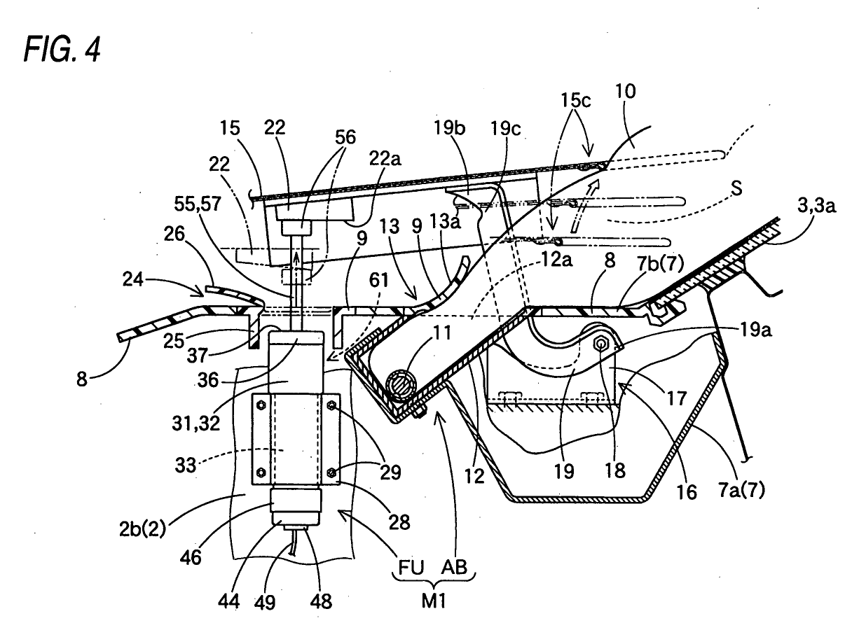

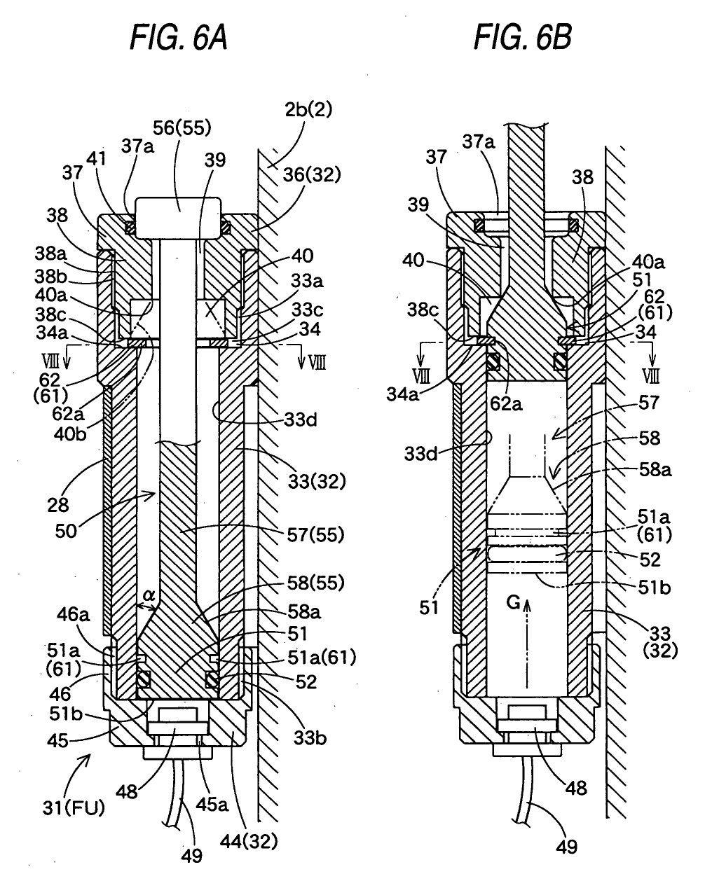

In addition, as is shown in FIG. 1, sensors 6, adapted to detect or predict a collision with a pedestrian as an object to be protected, are provided in a front bumper 5 of the vehicle V. In this construction, signals from the sensors 6 are inputted into an activation circuit, not shown, and this activation circuit is made to activate an inflator 11 (refer to FIG. 4) of the air bag apparatus AB and a gas generator 48 (refer to FIGS. 6A and 6B) functioning as a drive source in the actuator 31 of the lift-up apparatus FU when a collision of the vehicle V with a pedestrian is detected or predicted based on the signals from the sensors 6.

In addition, when used in this specification, front-rear or longitudinal and up-down or vertical directions are understood as coinciding, respectively, with longitudinal and vertical directions of the vehicle V1, and directions denoted by left and right are understood as coinciding, respectively, with the left and right of the vehicle V when the vehicle V is seen from the front towards the rear thereof.

As is shown in FIGS. 1 to 4, the hood panel 15 is such as to be provided to cover an engine room ER of the vehicle V from thereabove and is connected to a body 1 of the vehicle V by hinge portions 16 which are disposed, respectively, on the left-hand and right-hand edges in positions lying in the vicinity of the rear end 15c in such a manner as to be opened and closed at a front end thereof. The hood panel 15 is made of a sheet metal made of aluminum (aluminum alloy) and includes an outer panel 15a which lies on an upper surface side and an inner panel 15b which lies on a lower surface side of the hood panel 15 and whose strength is increased more than that of the outer panel 15a. The hood panel 15 is such as to be plastically deformed so as to absorb the kinetic energy of a pedestrian when the hood panel 15 receives the pedestrian. In addition, when a pedestrian collides with the vehicle V, the rear end 15c is raised by activating the actuators 31 of the lift-up apparatuses FU for the purpose of providing a large space above the engine room ER so that the amount of deformation of the hood panel 15 is increased. In addition, the lift-up apparatus FU of the embodiment functions to provide a large space s (refer to FIG. 4) between a cowl 7 and the rear end 15c of the hood panel 15 through which the air bag 10 is allowed to project outwards.

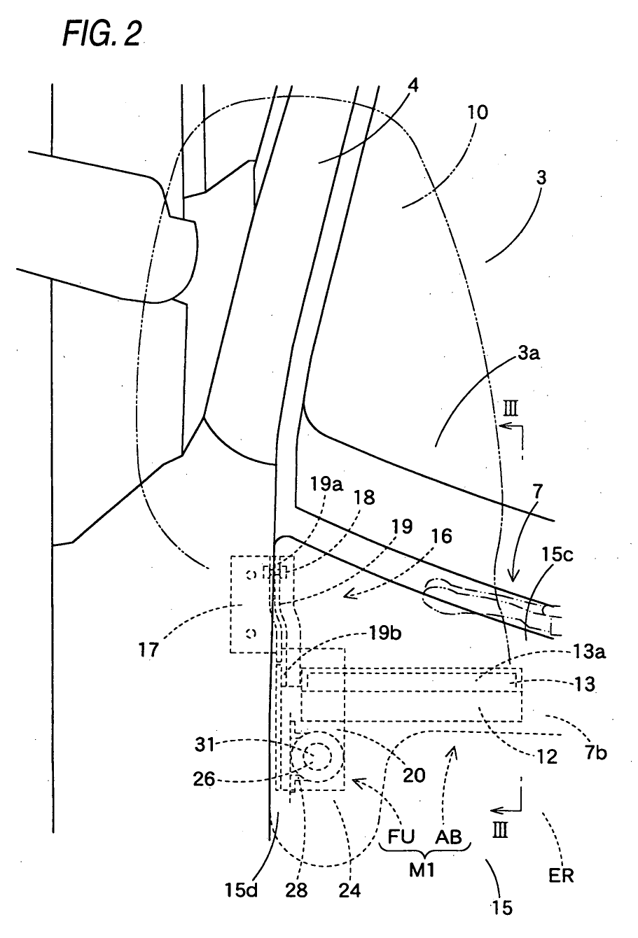

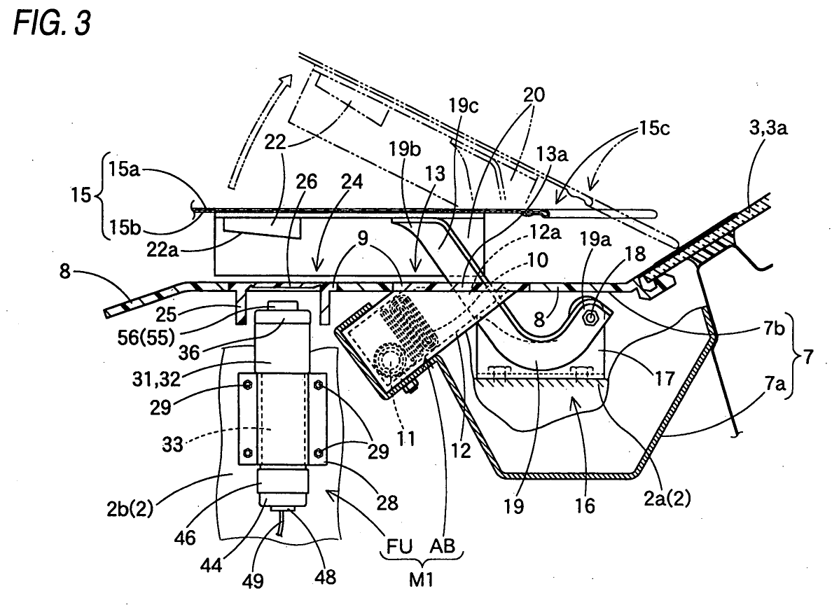

The hinge portions 16 are provided, respectively, on the left-hand edge 15d and the right-hand edge 15e in the positions lying on the rear end 15c side of the hood panel 15 (refer to FIG. 1) and each includes a hinge base 17 which is fixed to a mounting bracket 2a connected to a hood ridge reinforcement 2 on the body 1 side, a mounting bracket 20 which is fixed to the hood panel 15 side and a hinge arm 19 which is connected to the hinge base 17 and the mounting bracket 20 (refer to FIG. 3). As is shown in FIGS. 2, 3, each hinge arm 19 is configured to have a substantially semi-arcuate shape by curving an angle material made of a sheet metal in such a manner as to project downwardly or be concave upwardly. The hinge arm 19 is connected rotatably to the hinge base 17 at a hinge base 17 side proximal end 19a thereof by making use of a support shaft 18 and is connected to the mounting bracket 20 by making use of welding or the like at a distal end 19b which is spaced apart from the proximal end 19a. Each support shaft 18 is provided with its axis made to extend along the transverse direction of the vehicle V. Because of this, when opening the hood panel 15, a front end 15f side of the hood panel 15 (refer to FIG. 1) as well as the distal end 19 sides of the respective hinge arms 19 are raised so that the hood panel 15 is rotated upwards about the respective support shafts 18 as a rotating center so as to be opened at the front end 15f from a position indicated by solid lines to a position indicated by chain double-dashed lines in FIG. 3.

In addition, a portion of the hinge arm 19 lying in the vicinity of the distal end 19b is made into a plastic deformation portion 19c which is plastically deformed when the rear end 15c of the hood panel 15 is pushed up by support rod portions 55 when the actuators 31 are activated (refer to FIG. 4). Incidentally, a latch mechanism for locking a hood lock striker which is not shown but is disposed at the front end 15f of the hood panel 15 is provided at the front end 15f side of the hood panel 15 for normally closing the hood panel, and the front end 15f side of the hood panel 15 is prevented from being disengaged from the body 1 side by the latch mechanism which locks the hood lock striker, not shown, even when the rear end 15c of the hood panel 15 is raised.

As is shown in FIGS. 3, 4, the air bag apparatuses AB includes the air bag 10, the inflator 11 for supplying an inflation gas into the air bag 10, a case 12 which houses the air bag 10 and the inflator 11 and an air bag cover 13 for covering the case 12 which houses the air bag 10 and the inflator 11 in such a way as to allow the opening of the case 12. Such air bag apparatuses 10 are equipped in locations on the cowl 7 which lie below the positions on the left-hand edge 15d and the right-hand edge 15e at the rear end 15c of the hood panel 15. In the air bag apparatuses AB that are configured and equipped as described above, when the lift-up apparatuses FU are activated to raise the rear end 15c of the hood panel 15, the inflators 11 are activated to operate to supply the inflation gas into the corresponding air bags 10, which are folded, so that the folded air bags 10 are distended to project through the space S defined between the rear end 15c of the hood panel 15 and the cowl 7. Then, when the inflation gas is caused to flow thereinto, the air bags 10 push open door portions 13a of the air bag covers 13 which have covered openings 12a at rear end portion sides of the cases 12 and are then deployed to be distended to cover front sides of left and right front pillars 4, 4 (refer to FIG. 1).

As is shown in FIG. 3, the cowl 7 includes a metallic cowl panel 7a (made of a sheet metal) which lies on the body 1 side and has high rigidity and a cowl bar 7b lying above the cowl panel 7a. The cowl bar 7b is made of a synthetic resin and is provided to continue to a lower portion 3a of a windshield 3 at a rear end portion thereof. As is shown in FIG. 1, 2, the front pillars 4, 4 are provided on left and right sides of the windshield 3.

In addition, in the case of the embodiment, the cases 12 of the air bag apparatuses AB are attached to the cowl panel 7a. In addition, the cowl bar 7b is fabricated by the air bag covers 13 and actuator covers 24 which cover the actuators 31 from thereabove being molded integrally with other general portions. The actuator covers 24 are disposed above the left and right actuators 31, respectively, and include door portions 26 which are provided in areas surrounded by cylindrical sleeve portions 25 and are adapted to be push opened by head portions 56 of the support rod portions 55 of the actuators 31 when the actuators 31 are activated. The cowl bar 7b is molded with portions having different pliabilities provided therein and includes hard portions 8 and soft portions 9 which are more pliable than the hard portions 8. The soft portions 9 constitute the aforesaid air bag covers 13 and portions lying in the vicinity of the sleeve portions 25 including the door portions 26 in the actuator covers 24.

As is shown in FIGS. 3 to 5, the lift-up apparatus FU includes the actuator 31 and a receiving seat 22 which is provided on the hood panel 15 side. As is shown FIG. 1, the actuators 31 are provided below the positions lying on the left- and right-hand edges at the rear end 15c of the hood panel 15 in such a manner as to correspond to the two locations on the hood panel 15 where the left and right hinge portions 16 are disposed. As is shown in FIGS. 6A and 6B, each actuator 31 is configured as an actuator of piston cylinder type which utilizes as a drive source an operating gas G which is generated when the gas generator 48 is activated, and a piston rod 50 is housed within a cylinder 32. The receiving seat 22 is attached to a portion of a lower surface of the rear end 15c of the hood panel 15 where the mounting bracket 20 is provided, and a lower surface 22a of the receiving seat 22 is made to receive the head portion 56 at the distal end of the support rod portion 55 of the actuator 31 which moves upwards.

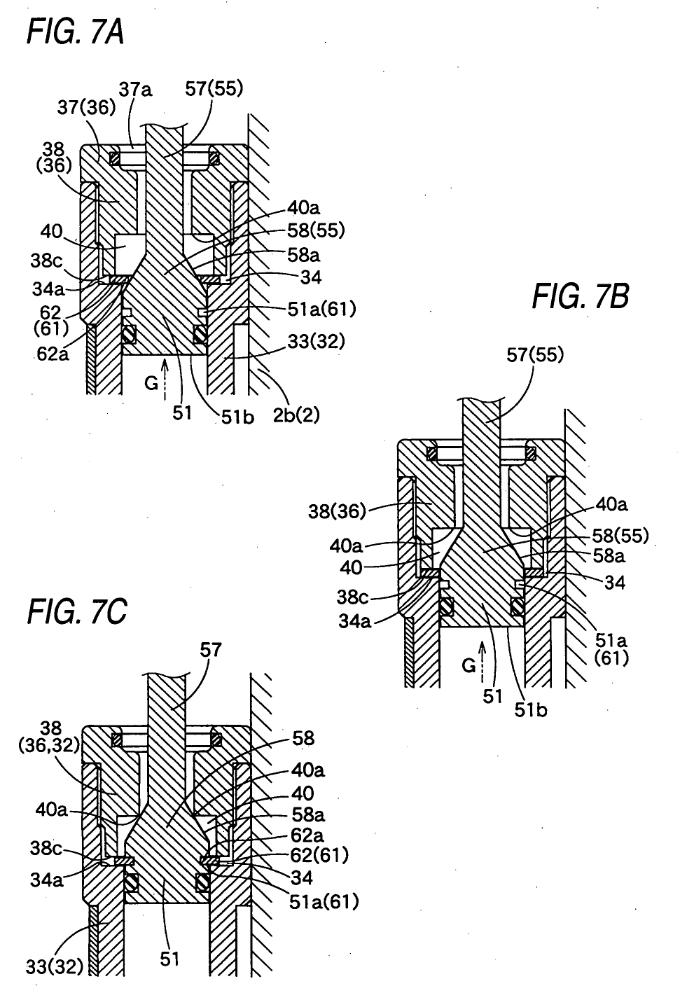

As is shown in FIGS. 3 to 5, the actuators 31 of the embodiment are held by mounting brackets 28 having a U-shaped cross section which are fastened to mounting flanges 2b connected to the hood ridge reinforcements 2 with bolts 29 and are provided below the positions on the hood panel 15 which lie on the left- and right-hand edges at the rear end 15c thereof. In addition, as is shown in FIGS. 6A to 7C, each actuator 31 includes the cylinder 32, the piston rod 50 which is housed slidably within the cylinder 32 and a lock mechanism 61 for restricting a backward movement (a descending movement in the case of the embodiment) of the piston rod 50 which has moved forwards (an ascending movement in the case of the embodiment).

As is shown in FIGS. 6A to 8B, the cylinder 32 includes a substantially cylindrical circumferential wall 33, and an upper cap 36 and a lower cap 44 which are fixed respectively to upper and lower ends of the circumferential wall 33. A recessed portion 33c is formed on an upper end inner circumferential surface of the circumferential wall 33 in such a manner as to be recessed along the full circumference of the circumferential wall 33 in a circumferential direction, and a bottom surface side of the recessed portion 33c is formed into an annular shape, so as to form a disposition stepped portion 34 where to dispose an annular elastic element 62. The disposition stepped portion 34 is provided in a position which substantially coincides with a position of a groove 51a in a piston portion 51 of the piston rod 50 which results after the piston rod 50 has completed its upward movement, whereby the annular elastic element 62 is supported by an upper surface 34a of the disposition stepped portion 34.

The annular elastic element 62 fits in the groove 51a of the piston portion 51 after the piston rod 50 has moved forwards (moved upwards in this embodiment), so as to make up the lock mechanism 61 for restricting a backward movement (a descending movement in this embodiment) of the piston rod 50. The annular elastic element 62 is disposed in the disposition stepped portion 34 in such a state that the annular elastic element 62 can be expanded to an outside diametrical dimension of the piston portion 51 in a restorable manner with an inner circumferential edge 62a made to project further radially inwards than an inner circumferential surface 33d of the circumferential wall 33 of the cylinder 32. In addition, in the case of this embodiment, the annular elastic element 62 is made up of a snap ring (a C ring) which is made of a spring steel.

The upper cap 36 on the upper end of the circumferential wall 33 includes a distal end wall portion 37 having a head portion accommodating recessed portion 37a which accommodates the head portion 56 of the support rod portion 55 of the piston rod 50 before it starts to operate and a substantially cylindrical inner wall portion 38 which is made to extend downwards with its outside diametrical dimension made smaller than the distal end wall portion 37 and which makes up an upper end inner circumferential surface of the cylinder 32. The inner wall portion 38 has an insertion hole 39 which is opened vertically throughout the upper cap 36 for a rod main body portion 57 of the support rod portion 55 to be inserted thereinto and a tapered portion accommodating recessed portion 40 which is disposed underneath the insertion hole 39 for accommodation of a tapered portion 58 of the piston rod 50 when the piston rod 50 moves upwards.

In addition, the inner wall portion 38 of the upper cap 36 includes on an outer circumferential surface 38b thereof an external thread 38a which screws in an internal thread 33a cut in an upper end inner circumference of the circumferential wall 33 of the cylinder 33. Additionally, the upper cap 36 is attached to the circumferential wall 33 with the rod main body portion 57 of the support rod portion 55 inserted into the insertion hole 39 and the external thread 38a on the inner wall portion 38 made to screw in the internal thread 33a on the circumferential wall 33. The annular elastic element 62 making up the lock mechanism 61 is held between a lower end face 38c of the inner wall portion 38 and the upper face 34a o the disposition stepped portion 34 while being permitted to be deformed in diametrically expanding and contracting directions in such a state that the inner circumferential edge 62a is made to project further radially inwards than the inner circumferential surface 33d of the circumferential wall 33 of the cylinder 32.

In addition, an O ring 41, which is brought into press contact with the head portion 56 of the support rod portion 55 is disposed on an inner circumferential surface of the head portion accommodating recessed portion 37a. By this configuration, the airtightness within the cylinder 32 is ensured and the looseness of the head portion 56 of the support rod portion 55 is prevented.

The lower cap 44 on the lower end of the circumferential wall 33 includes a distal end wall portion 45 which is disposed in such a manner as to close a lower end of the circumferential wall 33 and a substantially cylindrical circumferential wall portion 46 which extends upwards from an outer circumferential edge of the proximal end wall portion 45. The gas generator 48 is attached to the proximal end wall portion 45 by making use of a circumferential edge of an insertion hole 45a which is opened vertically throughout the lower cap 44. An internal thread 46a is cut in an inner circumferential surface of the circumferential wall portion 46 in such a manner as to screw on an external thread 33b which is provided on a lower end outer circumference of the circumferential wall 33 of the cylinder 32. In addition, the lower cap 44 is attached to the circumferential wall 33 by the internal thread 46a screwing on the external thread 33b in such a state that the gas generator 48 is attached to the proximal end wall portion 45.

A micro gas generator is used for the gas generator 48, and a lead wire 49 is connected to a lower end face of the gas generator 48 so that an electric signal from a control circuit, not shown, is inputted into the gas generator 48 therethrough. When an electric signal from the control circuit, not shown, is inputted into the gas generator 48, gunpowder incorporated in the gas generator 48 is ignited, and gas generating chemicals are then burned by the ignition of the gunpowder so as to generate a gas. The gas so generated is supplied to a lower surface 51b side of the piston portion 51 within the cylinder 32 as an operating gas G.

The piston rod 50 includes the piston portion 51 which is caused to move forwards by the operating gas G that is caused to flow into the cylinder 32 when the actuator 31 is activated and the support rod portion 55 which is made to extend coaxially in the forward direction (in the upward or ascending direction in the embodiment) from the piston portion 51 to such an extent that it projects from the distal end wall portion 37 of the cylinder 32 so as to support the hood panel 15 functioning as a receiving member for receiving an object to be protected.

The piston portion 51 has a disk shape and has the groove 51a which is recessed along the full circumference of an outer circumferential surface in a circumferential direction. The groove 51a fits on the annular elastic element 62 disposed in the disposition stepped portion 34 on the circumferential wall 33 of the cylinder 32 when the piston rod 50 completes a forward movement (an ascending movement in the embodiment) and thus, makes up the locking mechanism 61 for restricting a backward movement (a descending movement in the embodiment) of the piston rod 50. In addition, a piston ring 52, which is brought into press contact with the inner circumferential surface 33d of the circumferential wall 33 of the cylinder 32, is disposed on the outer circumferential surface of the piston portion 51 in a position lying further downwards than the groove 51a, so as to ensure airtightness between the piston portion 51 and the gas generator 48.

The support rod portion 55 includes the rod main body portion 57 which projects from the distal end wall portion 37 of the cylinder 32 when the support rod portion 55 moves forwards (ascends in the embodiment) and the tapered portion 58 which is disposed at a piston portion 51 side end portion and is adapted to expand diametrically the annular elastic element 62. In addition, the support rod portion 55 includes at an upper end of the rod main body portion 57 the cylindrical head portion 56 which is brought into abutment with the receiving seat 22 provided on the mounting bracket 20 at the rear end 15c of the hood panel 15 when the support rod portion 55 ascends, so as to push up the rear end 15c of the hood panel 15.

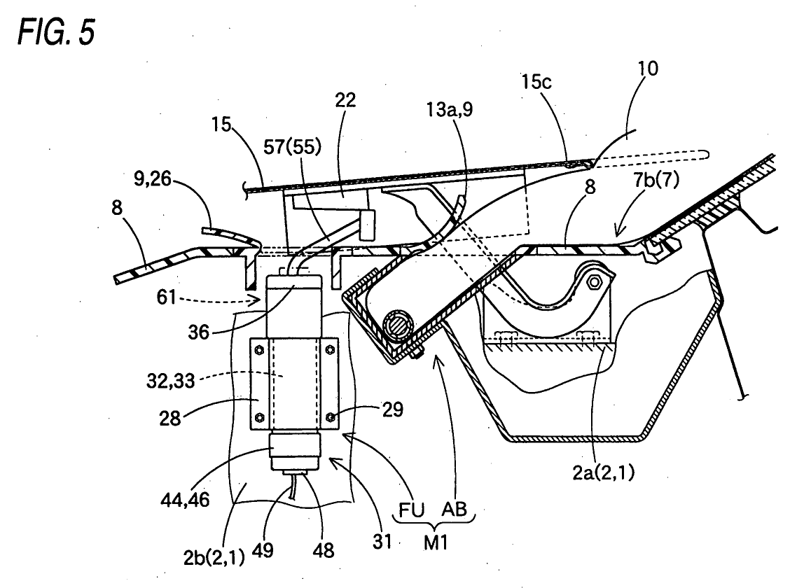

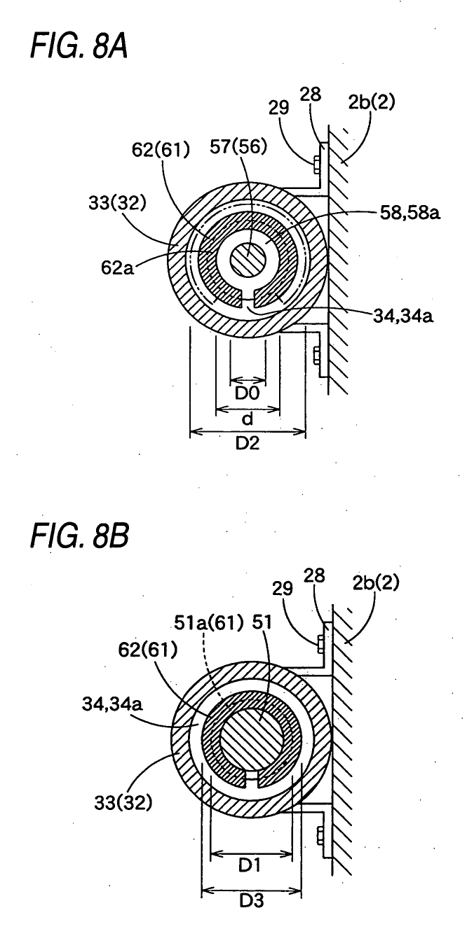

The rod main body portion 57 is formed into a vertically long cylinder and projects from the distal end wall portion 37 when the actuator 31 is activated to operate so as to ensure a raising stroke of the rear end 15c of the hood panel 15. As is shown in FIG. 5, the rod main body portion 57 is made of a metallic material such as steel so as to be plastically deformed. In addition, an outside diametrical dimension D0 of the rod main body portion 57 is made smaller than an inside diametrical dimension d of the annular elastic element 62 so that an outer circumferential surface of the rod main body portion 57 is brought into press contact with an inner circumferential surface of the annular elastic element 62 (refer to FIG. 8A).

The tapered portion 58 is substantially trapezoidal in vertical section and has a tapered outer circumferential surface (hereinafter, referred to as a “taper surface”) 58a which gradually expands diametrically from a lower end outer circumference of the rod main body portion 57 towards an upper end outer circumferential edge of the piston portion 51 until an outside diametrical dimension D1 (refer to FIG. 8B) of the piston portion 51 is reached. As is shown in FIGS. 7A to 7C, when the piston rod 50 ascends, the taper surface 58a starts to press contact the inner circumferential surface of the annular elastic element 62 after the rod main body portion 57 of the support rod portion 55 has passed through the annular elastic element 62. Thereafter, as the piston rod ascends, the tapered portion 58 expands gradually the inside diametrical dimension d of the annular elastic element 62 to the outside diametrical dimension D1 of the piston portion 51.

In addition, as is shown in FIGS. 6A to 7C, when an upper portion of the taper surface 58a of the tapered portion 58 is brought into abutment with an upper edge side inner circumferential edge of the tapered portion accommodating recessed portion 40 to thereby stop the ascending movement of the piston rod 50, the annular elastic element 62 which is being expanded diametrically fits in the groove 51a on the piston portion 51 by an elastic deformation made by an elastic force generated in the annual elastic element 62 itself in such a state, so as to restrict a backward movement of the piston rod 50. Namely, the annular elastic element 62 making up the lock mechanism 61 is restored from an outside diametrical dimension D2 resulting when it is diametrically expanded to become an outside diametrical dimension D3 (refer to FIG. 8B) which extends between the groove 51a of the piston portion 51 and the disposition stepped portion 34 in the circumferential wall 33 of the cylinder 32, so as to fit in the groove 51a making up the locking mechanism 61, whereby a backward movement of the piston rod 50 is restricted in that position.

In addition, as is indicated by chain double-dashed lines in FIG. 6A, an inner circumferential surface 40b making up the tapered portion accommodating portion 40 in the upper cap 36 of the cylinder may have a taper shape which is parallel to the taper surface 58a of the tapered portion 58 of the piston rod 50. As this occurs, since the substantially whole surface of the taper surface 58a of the tapered portion 58 is brought into abutment with the inner circumferential surface (the taper surface) 40b to thereby complete the ascending movement of the piston rod 50, the ascending movement of the piston rod 50 can be completed in a stable fashion.

In addition, while in the embodiment, the piston portion 51, the tapered portion 58 and the rod main body portion 57 are configured into the integral unit, they may, of course, be formed as separate members. In the event that the piston portion 51, the tapered portion 58 and the rod main body portion 57 are configured as separate members, the support rod portion can be built into the piston portion in a replaceable fashion by, for example, the support rod portion being screwed into and out of a threaded hole. In addition, in the event that the kinetic energy absorption amount of a pedestrian by the plastic deformation of the support rod portion is increased or decreased, the support rod portion may be replaced by a support rod portion in which the rod main body portion is made thicker so as to increase the bending rigidity of the support rod portion or a support rod portion in which the rod main body portion is thinner so as to decrease the bending rigidity. In addition, the material of the support rod portion may be changed in order to adjust the plastic deformation stress of the support rod portion.

In the pedestrian protection system M1 of the embodiment, when detecting or predicting a collision of the vehicle V with a pedestrian based on electric signals from the sensors 6, the activation circuit, not shown, activates the gas generator 48 in the actuator 31 of each lift-up apparatus FU and also activates the inflator 11 in each air bag apparatus AB.

Then, in the event that the gas generator 48 of the actuator 31 is activated, as shown in FIGS. 3, 4, 6A and 6B, the operating gas G generated by the gas generator 48 acts to push up the piston portion 51 within the circumferential wall 33 of the cylinder 32, the head portion 56 at the upper end of the support rod portion 55 which extends from the piston portion 51 push opens the door portion 26 of the actuator cover 24 to thereby be brought into abutment with the receiving seat 22. Further, the head portion 56 raises the rear end 15c of the hood panel 15 to thereby define the space S between the hood panel 15 and the cowl 7 on the rear end 15c side. In addition, in the event that the inflator 11 of the air bag apparatus AB is activated, as is indicated by chain double-dashed lines in FIGS. 1 and 2 and is shown in FIG. 4, the inflation gas generated by the inflator 11 is caused to flow into the air bag 10, which is folded and accommodated, and then, the air bag 10 is deployed to push open the door portion 13a of the air bag cover 13 so as to project to an upper side of the windshield 3. Furthermore, the air bag 10 passes through the space S so as to be inflated. Then, when having been completely inflated, the air bag 10 covers the front side of the front pillar 4.

In addition, in the actuator 31 of the embodiment, since the outside diametrical dimension D0 of the rod main body portion 57 which projects from the distal end wall portion 37 of the cylinder 32 when the rod main body portion 57 moves forwards is made to be smaller than the inside diametrical dimension d of the annular elastic element 62, when the actuator 31 is activated to operate, causing the piston rod portion 51 of the piston rod 50 disposed within the cylinder 32 to move forwards, the outer circumferential surface of the rod main body portion 57 of the support rod portion 55 which extends from the piston portion 51 is prevented from being brought into press contact with the inner circumferential surface of the annular elastic element 62. Namely, since when the piston rod 50 moves forwards, the rod main body portion 57 is not pressed against by the elastic force generated in the annular elastic element 62 in the diametrically contracting direction, the piston rod 50 can move forwards in a smooth fashion.

Thereafter, when the tapered portion 58 of the support rod portion 55 passes through the position where the annular elastic element 62 is provided, since the tapered portion 58 gradually expands the inside diameter of the annular elastic element 62 to the outside diametrical dimension D0 of the piston portion 51, the annular elastic element 62 is put into the state in which it holds the biasing force that attempts to act in the diametrically contracting direction so as to allow the annular elastic element 62 to fit into the groove 51a on the piston portion 51. Following this, when the piston rod 50 has completed its forward movement, the annular elastic element 62 is restored in the diametrically contracting direction to thereby fit into the groove 51a on the piston portion 51, thereby making it possible to restrict the backward movement of the piston rod 50. In addition, in the event that the tapered portion 58 includes the taper surface 58a having the angle a (refer to FIG. 6A) which causes the annular elastic element 62 to be diametrically expanded smoothly to the outside diametrical dimension D0 of the piston portion 51, such a tapered portion does not have to be provided along the full length of the support rod portion 55. Because of this, in proportion to reduction in length of the tapered portion 58, the piston rod 50 can move forwards more quickly until the tapered portion 58 of the support rod portion 55 is brought into contact with the annular elastic element 62. In addition, the tapered portion 58 is desirably configured to have a length dimension which is in a range of about one third or less the stroke distance resulting when the support rod portion 55 moves forwards (this stroke distance being made to be about one eighth in this embodiment). In addition, the angle of the taper surface 58a is desirably set to the angle a which ranges from 30 degrees to 45 degrees (30 degrees in the embodiment) based on the moving direction of the support rod portion 55 so that the annular elastic element 62 can be expanded diametrically in a smooth fashion and that the length dimension of the tapered portion 58 can be kept decreased.

Consequently, in the actuator 31 of the embodiment, even though the configuration is adopted in which the annular elastic element 62 is used in the lock mechanism 61, the piston rod 50 can be caused to move forwards as smoothly as possible.

In addition, according to the embodiment, when the hood panel 15, which functions as the receiving member, receives a pedestrian, which constitutes an object to be protected, the hood panel 15 is plastically deformed and absorbs the kinetic energy of the pedestrian so as to receive the pedestrian while mitigating impact generated then. Further, as is shown in FIG. 5, since the rod main body portion 57 of the support rod portion 55 is also plastically deformed as being bending deformed so as to absorb the kinetic energy of the pedestrian, the pedestrian can be received in such a state that the impact is mitigated further by the deformation of the support rod portion 55 in addition to the deformation of the hood panel 15.

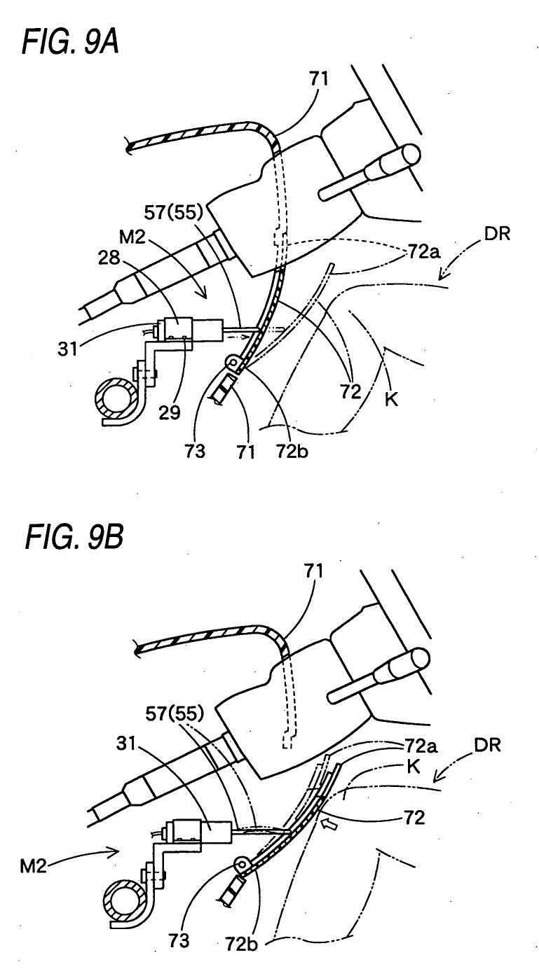

In addition, in the actuator 31 of the embodiment, while the forward movement is described as the ascending movement and the backward movement as the descending movement, the operating directions are not limited thereto. For example, the actuator of the invention may be applied to an application where it operates in a horizontal direction, and the automotive safety equipment in which the actuator of the invention is used may be applied to safety equipment other than the pedestrian protection system M1. For example, as is shown in FIGS. 9A and 9B, the actuator 31 may be applied to a knee protection system M2 as automotive safety equipment for receiving safely the knees of the driver by a knee panel.

This knee protection system M2 is such as to protect the knees K of the driver DR by receiving the knees K, an object to be protected, of the driver DR. When the vehicle is involved in a frontal collision, the actuator 31 is activated so as to push out a knee receiving material 72 disposed in an instrument panel 71 to the rear. Then, when the knees K move forwards to collide with the knee receiving material 72, the rod main body portion 57 of the support rod portion is bent to be plastically deformed so as to absorb the kinetic energy of the driver DR while receiving the knees. In addition, the knee receiving member 72 is supported rotatably at a hinge portion 73 attached to the instrument panel 71 at a lower end 72b side, so that an upper end 72a is pushed to the rear about the hinge portion 76 functioning as a rotating center when the actuator 31 is activated to operate.

In addition, in the actuator 31 of the embodiment, while the operating gas G generated by the gas generator 48 is used as the drive source for moving the piston rod 50 forwards, water, oil and air may, of course, be used as an operating fluid, so that their water pressure, oil pressure and air pressure may be made use of as the drive source.

Further, as the drive source for moving the piston rod forwards, the suction force of a solenoid and the biasing force (restoring force) of a compressed spring can be used. For example, in the case of the suction force of a solenoid being used, a movable iron core is disposed within the cylinder as a piston rod. When exciting coils disposed around the circumference of the movable iron core in the cylinder are energized, the piston can be caused to move forwards. In addition, in the case of a spring being used, the piston rod is connected to a free end of a compressed coil spring, and a distal end of the piston rod or the compression coil spring is locked by a stopper which is made up of a solenoid in such a manner as to be pulled in. Then, in the event that the stopper so configured is made to be pulled in so as to cancel the locking, the piston rod moves forwards by the restoring force of the compression coil spring.

What is claimed is:

1. An actuator for use in automotive safety equipment, comprising a cylinder, a piston rod disposed to move forwards within the cylinder, and a lock mechanism for restricting a backward movement of the piston rod that has once moved forwards,
the piston rod comprising:
a piston portion which moves forwards when in operation; and
a support rod portion extended from the piston portion in a forward direction, so as to project from a distal end wall portion of the cylinder to support a receiving member for receiving an object to be protected,
the lock mechanism comprising:
an annular elastic element provided in a position on an inner circumferential surface side of the cylinder where the piston rod is disposed after the piston rod has moved forwards such that an inner circumferential edge is made to project further than an inner circumferential surface of the cylinder and adapted to expand diametrically in a restorable manner; and
a groove provided along an outer circumferential surface of the piston portion so that the annular elastic element is allowed to be fitted therein so as to restrict a backward movement of the piston rod that has once moved forwards, wherein
the support rod portion comprises:
a rod main body portion having a smaller diameter than an inside diametrical dimension of the annular elastic element and adapted to project from the distal end wall portion of the cylinder when the piston rod moves forwards; and
a tapered portion provided at a piston portion side end portion of the support rod portion and having a taper surface which is gradually expanded diametrically towards the piston portion until an outside diametrical dimension of the piston portion is reached.
